(19) United States
(12) Patent Application Publication
(10) Pub. No.: US 2014/0288285 A1
(43) Pub. Date: Sep. 25, 2014

(54) PROCESS FOR OBTAINING LOW MOLECULAR LIGNIN (LML)

(71) Applicant: ANNIKKI GMBH, Graz (AT)

(72) Inventors: Thomas Ters, Wien (AT); Karin Fackler, Wien (AT); Kurt Messner, Wien (AT); Ortwin Ertl, Vasoldsberg (AT)

(73) Assignee: ANNIKKI GMBH, Graz (AT)

(21) Appl. No.: 14/360,537

(22) PCT Filed: Nov. 26, 2012
(86) PCT No.: PCT/EP2012/073571

§ 371 Date: May 23, 2014

(30) Foreign Application Priority Data
Nov. 28, 2011 (EP) 11190969.3

(51) Int. Cl. C07G 1/00

(52) U.S. Cl. CPC C07G 1/00
USPC 530/500

(57) ABSTRACT

A process for obtaining resin or plastics using a lignocellulosic material by treating a lignocellulosic material with an aqueous extraction solution having a content of a C₁₋₄-alcohol of from 70% v/v to 95% v/v at a pH-value of from 12 to 14, whereby a first aqueous solution of low-molecular lignin (LML) is obtained, which is converted into resin or plastics; and a method of obtaining LML and a method of concentrating LML, wherein the first aqueous solution of LML is used for the treatment of additional lignocellulosic material in order to obtain aqueous solutions in which the LML is enriched compared with the first aqueous solution.

The present invention relates to a process for obtaining LML from a lignocellulosic material by alkaline extraction and its conversion into resin or plastics.

In connection with the shortage of crude oil, the renewable raw material lignocellulose (straw, wood, paper waste, etc.) is becoming more and more important as a starting material for chemical products and fuels. Lignocellulose consists of the ultrastructurally cross-linked polymeric main components cellulose, hemicellulose and lignin, which often constitute about 85-90% of the raw material.

The cleavage of the components present as polymers and their fractionation into individual product streams as well as their further processing into higher-value products is the task of biorefineries of a biochemical platform. The profitability of such biorefineries depends largely on which added value can be drawn from the product streams. This is, in turn, heavily influenced by the purity and the properties of the individual product streams, since downstream fractionation processes can be difficult and costly. Hence, a process in which the cleavage of the individual main components occurs as selectively as possible may be considered as ideal. For this purpose, it is advantageous to place the step of extracting LML at the start of biorefinery methods.

Lignin is gaining very much in economic importance as a substitute for petrochemically produced aromates. In turn, the possible uses of the obtained lignin are determined very much by the chemical composition thereof, most notably, however, the molecular weight of the obtained lignin fraction. Depending on the manufacturing process, lignins may exhibit highly different properties.

By means of the recently developed Lignoboost process (P. Tomani, 2009, The Lignoboost Process, NWBC-2009 The 2^{nd} Nordic Wood Biorefinery Conference, Helsinki, Finland, Sep. 2-4, 2009, 181-188.), lignin can be separated from the thick liquor of the kraft pulping and can be used commercially. In addition, this brings relief for the recovery boiler, which allows a capacity increase in the pulp mill The sulfate lignin accruing thereby is partly highly condensed due to repolymerization reactions occurring in the course of boiling, furthermore contains approx. 2% of sulfur in the form of thiol groups and is excellently suitable for thermal utilization. However, its range of application as a chemical raw material is very limited because of the smell caused by the thiol groups. From the traditional sulfite process, lignosulfonates can be obtained, which may be used in certain applications due to their water solubility. The sulfur content is disadvantageous in both lignins.

In particular, however, sulfur-free, low-molecular lignin fractions, preferably of a high degree of purity, are in demand for applications in the manufacture of plastics and resins.

Sulfur-free lignins originate mainly from organosolv processes, from soda pulping or from biorefinery processes.

Among the methods used in biorefineries for the cleavage of lignocellulose, alkaline methods should be emphasized specifically, the cleavage principle of which being primarily the removal of the lignin. The underlying chemical principle is alkaline hydrolysis, by means of which both the bond between lignin and hemicellulose and acetic acid hemicellulose esters are cleaved.

Such a method was described in Avgerinos & Wang (1983), Biotechnology and Bioengineering, Vol XXV, 67-83. In U.S. Pat. No. 4,395,543, a method for the cleavage of lignocellulose is claimed in greater detail, wherein an extraction solution consisting of water, between 40 and 75% of alcohol and a pH of between 11 and 14 is used. In addition, it is evident from the patent that the amount of released lignin will approach zero if the ethanol concentration is increased to up to 100%. Furthermore, it is described that also the amount of released sugars will approach zero if the alcohol concentration is raised to 100%. The molecular weight of the lignins released in the process is not described.

Surprisingly, it has been shown in some studies with regard to alkaline cleavage with ethanol that the cleavage parameters have a decisive impact not only on the amount of the extracted lignin, but also on the molecular weight thereof. Especially by choosing the alcohol concentration in an aqueous alkaline solution, LML can be obtained selectively from a lignocellulosic material, e.g., lignocelluloses, or, respectively, the molecular size of the extracted lignin can be influenced, whereby it has surprisingly become apparent that a sulfur-free LML produced in this manner is particularly suitable for being converted into resin or plastics.

In one aspect, the present invention provides a process for obtaining resin or plastics using a lignocellulosic material, which process is characterized in that
a) a lignocellulosic material is treated with an aqueous extraction solution having a content of a C₁₋₄-alcohol, in particular ethanol or isopropanol, of from 70% v/v to 95% v/v, in particular from 75% v/v to 85% v/v, at a pH-value of from 12 to 14, whereby an aqueous solution of low-molecular lignin (LML) is obtained, and
b) the low-molecular lignin obtained according to a) is converted into resin or plastics.

A process which is provided by the present invention is herein referred to also as the “process according to (of) the present invention”.

For example, it has surprisingly been found that approximately 16% of the LML (based on the total lignin) can be extracted from wheat straw in an aqueous alcoholic solution at a temperature of 70° C. and a pH-value of approximately 13 already after 30 minutes, if the alcohol content in the aqueous solution amounts to 80% v/v. If the alcohol content is raised to above 85% under the above conditions, the amount of extracted LML will decrease. Surprisingly, the obtained lignin thereby exhibits a very low molecular weight (Mw 1340, Mn 850) with a very narrow molecular weight distribution (Pd 1.58).

Furthermore, it has been found that the extracted components LML can be concentrated by repeatedly recycling the extraction solution onto a fresh lignocellulose substrate, the spent caustic soda solution having been added previously in each case. As shown in Example 2, the amount of low-molecular lignin surprisingly increases linearly in the recycling solution with the 6 recycling steps that have been shown and does not follow a saturation curve, as might have been expected. After 6 cycles, the lignin content could be increased from 1.88 mg/ml to 12.25 mg/ml. The number of extraction cycles can be chosen freely depending on the desired final concentration and can be performed, for example, until saturation of the solvent with LML.

As a result of the successful concentration, a final concentration of LML is achieved which renders the separation of the low-molecular lignin economically sustainable. Furthermore, the amount of alcohol to be used, based on the total amount of treated biomass, is drastically reduced by the recycling.

In a further aspect, the present invention provides a process for obtaining low-molecular lignin (LML) from a lignocellulosic material, in particular lignocellulose, wherein a lignocellulosic material is treated with an aqueous extraction solution having a content of a C₁₋₄-alcohol, in particular ethanol or isopropanol, of from 70% v/v to 95% v/v, in particular from 75% v/v to 85% v/v, at a pH-value of from 12 to 14, whereby a first aqueous solution of LML is obtained, characterized in that the first aqueous solution of LML is used to treat additional lignocellulosic material, in particular lignocellulose, in order to obtain a second aqueous solution in which the LML is enriched compared with the first aqueous solution; wherein said second aqueous solution, in which the LML is enriched, is optionally used to treat additional lignocellulosic material, in particular lignocellulose, in order to obtain further aqueous solutions in which the LML is enriched compared with the second aqueous solution;

and in a further aspect

A process for concentrating low-molecular lignin (LML) in a first aqueous solution which is obtained by treating a lignocellulosic material with an aqueous extraction solution having a content of a C₁₋₄-alcohol, in particular ethanol or isopropanol, of from 70% v/v to 95% v/v, in particular from 75% v/v to 85% v/v, at a pH-value of from 12 to 14, characterized in that said first aqueous solution is used for the treatment of additional lignocellulosic material in order to obtain further aqueous solutions in which the NLML is enriched compared with the first aqueous solution.

As lignocellulosic material, in particular lignocellulose hardwood, softwood (coniferous trees), straw, bagasse or annual and perennial grasses have proved to be advantageous.

In a further aspect, the present invention provides process according to the present invention which is characterized in that hardwood, softwood, straw, bagasse or annual and perennial grasses, in particular hardwood, straw, bagasse or annual and perennial grasses, is/are used as the lignocellulosic material.

Processes according to the present invention exhibit a number of advantages compared with known methods.

The advantages of a method according to the present invention in comparison to known methods include, for example,
the receipt of a high LML concentration in the aqueous alcoholic solution by which the separation of LML is facilitated;
a lower need of extraction solution compared with known methods, which is associated with the high LML concentration;
the separation of LML and high-molecular lignin (HML), which, in general, would accumulate jointly in an extraction solution according to the prior art;
the fact that less base (e.g., NaOH) needs to be added for further fractionation steps for the selective production of lignin (HML) and for recycling the lignin solutions used in the process compared with methods according to the prior art, since less base is consumed for saponification;
the fact that fewer amounts of salts will accumulate in further fractionation steps because of the diminished need of NaOH;
the fact that the lignin solution can thus be used for new amounts of straw and, as a result, the concentration of lignin in solution can also be increased and, respectively, the amount of solvents required in relation to the straw can be reduced;
the fact that further lignin extraction steps are not disturbed by the presence of acetate (and other anions);
the fact that LML does not have to be removed separately following a further lignin extraction step in which HML accrues;
the provision of high-purity sulfur-free LML for the production of plastics and resins.

In a process according to the present invention, it has been found that low-molecular lignin having an Mw (average molecular weight) of 2000 and less, e.g. less, such as, e.g. an Mw of from 1300 to 1700, can be obtained.

In a further aspect, the present invention provides a process according to the present invention which is characterized in that the low-molecular lignin obtained in a) has an Mw of 2000 and less.

In a process according to the present invention, it has been found that low-molecular lignin having an Mn (average molecular number) of 1100 and less, e.g. less, such as, e.g. an Mn of from 800 to 1050, can be obtained.

In a further aspect, the present invention provides a process according to the present invention which is characterized in that the low-molecular lignin obtained in a) has an Mn of 1100 and less.

In a process according to the present invention, it has been found that low-molecular lignin having a polydispersity of 2 and less, e.g. less, such as, e.g. a polydispersity of from 1.3 to 1.8, can be obtained.

In a further aspect, the present invention provides a process according to the present invention which is characterized in that the low-molecular lignin obtained in a) has a polydispersity of 2 and less.

In a process according to the present invention, it has been found that low-molecular lignin having a sugar content of 2% and less, e.g. less, can be obtained.

In a further aspect, the present invention provides a method according to the present invention which is characterized in that the low-molecular lignin obtained in a) has a sugar content of 2% and less.

### DESCRIPTION OF THE FIGURES

FIG. 1 shows the time course of the lignin concentration in the extraction solution at 70° C. and with different ethanol contents. The minutes (min) are thereby plotted on the x-axis. The bars show the lignin concentration in mg/mL in each case from the left to the right, with an ethanol concentration amounting respectively to 40% v/v (1), 60% v/v (2), 80% v/v (3), 90% v/v (4), 95% (5) v/v and 100% v/v (6).

FIG. 2 shows the increase in the lignin content (mg/mL) in the extraction solution in case that the solution is being recycled. The number of cycles is thereby plotted on the x-axis. As can be seen in FIG. 2, the lignin content in the extraction solution surprisingly increases virtually linearly with the number of cycles.

In the following examples, preferred embodiments of the invention are described in more detail. All temperatures are indicated in ° Celsius.

The following abbreviations are used:

M_{w} average molecular weight (molecular weight average)

Mₙ average molecular number (molecular number average)

HPSEC High Performance Size Exclusion Chromatography

P_{d} polydispersity

Polydispersity is a measure of the width of a molar mass distribution (MMV). The larger Q, the wider is the MMV, with Q representing the fraction of Mw by Mn and being larger than 1. The molar mass distribution indicates the distribution for a particular substance, namely the proportional distribution of the molar mass of the contained molecules.

### EXAMPLE 1

### Time Course of the Lignin Concentration in the Extraction Solution at 70° C. and with Different Ethanol Contents

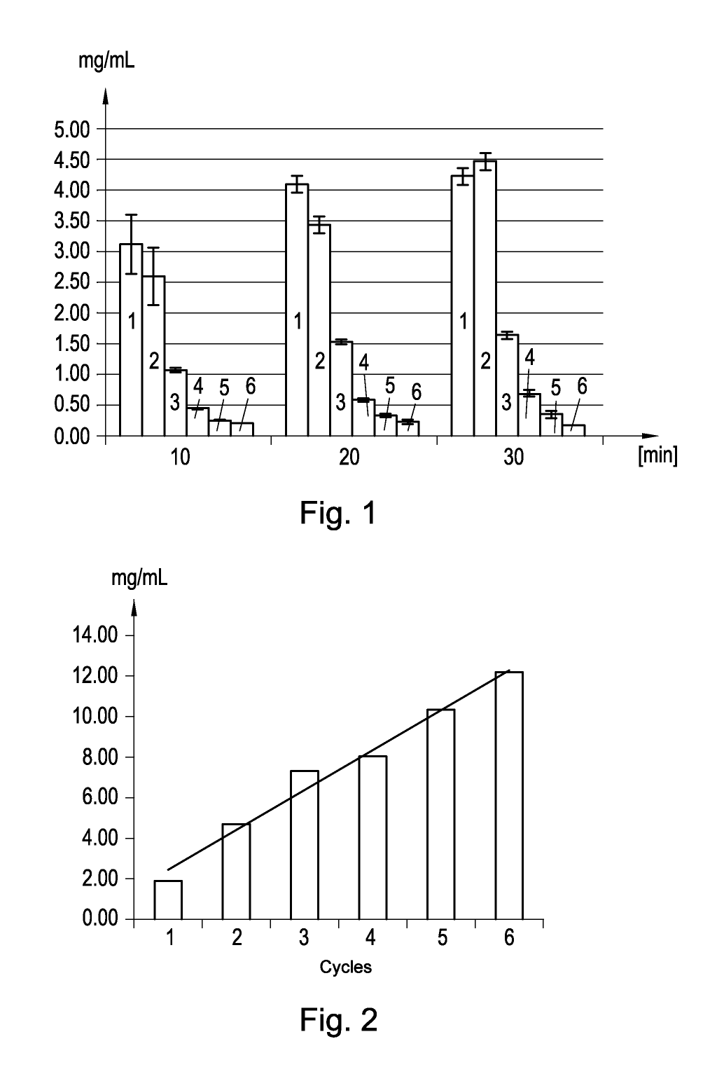

10 g of shredded wheat straw was suspended in a 500 mL reaction vessel in 200 mL (5% solids content) of a solution preheated to 70° C. and consisting of water/ethanol at different ratios (40%, 60%, 80%, 90%, 95%, 100% EtOH) and 0.8 g NaOH. The suspension was continuously stirred magnetically at 200 rpm and 70° C. for 10, 20 or 30 minutes. Thereupon, the solids content was separated by filtration. The lignin content of the solution was measured photometrically at 280 nm (ε=19.4 L g⁻¹ cm⁻¹), and the molecular weight of the dissolved lignin was determined via an alkaline HPSEC system (TSK-G500PW, TSK-G400PW, TSK-G300PW, Tosoh) with UV detection. As can be seen in FIG. 1, most of the lignin will be dissolved during the surveyed time period of 30 minutes at ethanol concentrations of between 40% and 60%. With higher ethanol concentrations, the yield decreases drastically.

By studying the molecular weights of said fractions, it becomes evident that, with ethanol contents of 40% and 60% in the extraction solution, the molecular weight and the polydispersity of the extracted lignin are very similar, but that surprisingly an LML of low polydispersity will be dissolved starting from 80% EtOH in the extraction solution. This becomes evident from FIG. 2.

In the following Table 1, the molecular weight distribution of the lignins extracted at different ethanol concentrations (T=70° C., t=30 min) is illustrated:

TABLE 1

| Sample | M_{w} | Mₙ | P_{d} |
|---|---|---|---|
| 40% EtOH | 2290 | 1000 | 2.30 |
| 60% EtOH | 2900 | 1030 | 2.82 |
| 80% EtOH | 1340 | 850 | 1.58 |
| 90% EtOH | 1330 | 850 | 1.57 |
| 95% EtOH | 1330 | 850 | 1.57 |
| 100% EtOH | 1370 | 850 | 1.62 |

### EXAMPLE 2

### Recycling of the LML Solution

In this trial, it is to be shown that the LML extraction solution can be recycled for further extractions.

10 g of shredded wheat straw was suspended in a 500 mL reaction vessel in 200 mL (5% solids content) of a solution consisting of 20% water, 80% ethanol and 0.8 g NaOH. The suspension was continuously stirred magnetically at 200 rpm, 70° C. for 30 minutes. After the extraction, the solution was separated from the solid by filtration, adjusted to the initial pH value with new NaOH, and fresh straw (5% w/v) was added.

The suspension was again treated under the conditions as described above and subjected to a further recycling step after the separation of the solid.

Before each recycling step, a sample was taken, and the lignin content of the solution was determined photometrically.

As can be seen in FIG. 2, the lignin concentration rises relatively linearly in the solution with each recycling step. From the solid, which was fresh in each case, 1.97 mg/mL of lignin on average was removed per extraction step. Deviations from those values can be explained by the variability of the extraction material.

By means of HPSEC, the molecular weight of the lignin was determined after each cycle. As can be seen from Table 2 below, in which the molecular weights of the lignin are illustrated in the individual stages of recycling, the molecular weight changes from Extraction 1 to Extraction 6 by only about 10%, that is, despite recycling, only the LML is always extracted from the matrix.

TABLE 2

| Cycles | M_{w} | Mₙ | P_{d} | Cycles |
|---|---|---|---|---|
| 1 | 1510 | 930 | 1.62 | 1 |
| 2 | 1490 | 820 | 1.82 | 2 |
| 3 | 1480 | 920 | 1.61 | 3 |
| 4 | 1540 | 950 | 1.62 | 4 |
| 5 | 1600 | 960 | 1.67 | 5 |
| 6 | 1660 | 970 | 1.71 | 6 |

### EXAMPLE 3

### Use of Poplar as a Substrate

10 g of chipped poplar was suspended in a 500 mL reaction vessel in 200 mL (5% solids content) of a solution consisting of 20% water, 80% ethanol and 0.8 g NaOH. By way of comparison, a trial without ethanol was conducted at an NaOH concentration of 1 g/L. Both suspensions were continuously stirred magnetically at 200 rpm, 70° C. for 18 hours. After the treatment, the solutions were separated from the solid by filtration, and the molecular weight of the extracted lignin was determined by HPSEC.

As is evident from Table 3 below, in which the molecular weights of the lignins extracted from poplar can be seen, the system used allows to extract also a low-molecular fraction from softwoods, whereby the influence of the ethanol in the cleavage solution being evident also in this case.

TABLE 3

| Sample | M_{w} | Mₙ | P_{d} |
|---|---|---|---|
| 80% EtOH | 1480 | 1050 | 1.41 |
| without EtOH | 3800 | 1230 | 3.09 |

1. A process for obtaining resin or plastics using a lignocellulosic material, comprising:
a) treating a lignocellulosic material with an aqueous extraction solution having a content of a C₁₋₄-alcohol of from 70% v/v to 95% v/v at a pH-value of from 12 to 14, whereby an aqueous solution of low-molecular lignin (LML) is obtained, and
b) converting the low-molecular lignin obtained according to a) into resin or plastics.

2. A process according to claim 1, wherein in a), a first aqueous solution of a low-molecular lignin is obtained which is used to treat additional lignocellulosic material in order to enrich additional low-molecular lignin in said first solution.

3. A process according to claim 1, wherein hardwood, softwood, straw, bagasse, or annual and perennial grasses is/are used as the lignocellulosic material.

4. A process according to claim 1, wherein the low-molecular lignin obtained in a) exhibits an Mw of 2000 and less.

5. A process according to claim 1, wherein the low-molecular lignin obtained in a) exhibits an Mn of 1100 and less.

6. A process according to claim 1, wherein the low-molecular lignin obtained in a) exhibits a polydispersity of 2 and less.

7. A process according to claim 1, wherein the low-molecular lignin obtained in a) has a sugar content of 2% and less.

8. A process for obtaining low-molecular lignin from a lignocellulosic material, comprising:
treating a lignocellulosic material with an aqueous extraction solution having a content of a C₁₋₄-alcohol of from 70% v/v to 95% v/v at a pH-value of from 12 to 14, whereby a first aqueous solution of low-molecular lignin is obtained, wherein the first aqueous solution of low-molecular lignin is used to treat additional lignocellulosic material in order to obtain a second aqueous solution in which the low-molecular lignin is enriched compared with the first aqueous solution.

9. A process according to claim 8, wherein the second aqueous solution, in which the low-molecular lignin is enriched, is used to treat additional lignocellulosic material in order to obtain further aqueous solutions in which the low-molecular lignin is enriched compared with the second aqueous solution.

10. A process for concentrating low-molecular lignin in a first aqueous solution, comprising
by treating a lignocellulosic material with an aqueous extraction solution having a content of a C₁₋₄-alcohol of from 70% v/v to 95% v/v at a pH-value of from 12 to 14, wherein said first aqueous solution is used for the treatment of additional lignocellulosic material in order to obtain further aqueous solutions in which the low-molecular lignin is enriched compared with the first aqueous solution.

11. A process according to claim 1, wherein the C₁₋₄-alcohol comprises ethanol or isopropanol.

12. A process according to claim 1, wherein the aqueous extraction solution has a content of a C₁₋₄-alcohol of from 75% v/v to 85% v/v.

13. A process according to claim 2, wherein the additional lignocellulosic material comprises lignocellulose.

14. A process according to claim 8, wherein the C₁₋₄-alcohol comprises ethanol or isopropanol.

15. A process according to claim 8, wherein the aqueous extraction solution has a content of a C₁₋₄-alcohol of from 75% v/v to 85% v/v.

16. A process according to claim 9, wherein the additional lignocellulosic material comprises lignocellulose.

17. A process according to claim 10, wherein the C₁₋₄-alcohol comprises ethanol or isopropanol.

18. A process according to claim 10, wherein the aqueous extraction solution has a content of a C₁₋₄-alcohol of from 75% v/v to 85% v/v.

19. A process according to claim 10, wherein the additional lignocellulosic material comprises lignocellulose.
